(19) United States
(12) Patent Application Publication
(10) Pub. No.: US 2005/0013613 A1
(43) Pub. Date: Jan. 20, 2005

(54) Optical burst switch network system and method with just-in-time signaling

(75) Inventors: Daniel S. Stevenson, Chapel Hill, NC (US); Mark C. Cassada, Hillsborough, NC (US); Pronita Mehrotra, Hillsborough, NJ (US)

Correspondence Address: McDERMOTT, WILL & EMERY, 600 13th Street, N.W., Washington, DC, 20005-3096, US

(73) Assignee: MCNC RESEARCH AND DEVELOPMENT INSTITUTE

(21) Appl. No.: 10/849,204

(22) Filed: May 20, 2004

Related U.S. Application Data
(60) Provisional application No. 60/472,630, filed on May 22, 2003.
(60) Provisional application No. 60/472,633, filed on May 22, 2003.
(60) Provisional application No. 60/472,634, filed on May 22, 2003.

(51) Int. Cl. H04B 10/20

(52) U.S. Cl. 398/60

(57) ABSTRACT

Optical burst switch network system and method with Just-in-Time (JIT) signaling and advanced data transmission and memory access and management. The system and method allow concurrent data transmission having arbitrary signal types, such as analog and digital signal types, in which the JIT signaling allows for subsequent simultaneous transmission of optical signals that do not require electro-optical conversion. The system includes an optical signal bus having a passive star coupler. A plurality of network adapters that are in optical communication with the optical signal bus and in network communication with network terminal devices are provided. The network adapters include receivers, transmitters and control logic that allows for bi-directional movement of data signals as bursts between the terminal equipment and the network system. The transmitter and receiver may be fixed or tunable. The system further includes an optical bus controller in optical communication with the optical signal bus that processes signals from the optical signal bus to connect a requested network adapter to a requesting network adapter in accordance with the user-to-network protocol. The network system implements a just-in-time signaling protocol to signal nodes in the network that burst communications are forthcoming. Optionally, the system allows comprehensive memory access in a Local Area Network (LAN). The nodes in the network are capable of seamlessly addressing memories of all other nodes that comprise the network.

### RELATED APPLICATIONS

This application claims the benefit of priority from the following patent applications:
U.S. provisional patent application No. 60/472,630, titled “OPTICAL BURST SWITCH LOCAL AREA NETWORK ARCHITECTURE;”
U.S. provisional patent application No. 60/472,633, titled “METHODS FOR DATA TRANSMISSION AND MEMORY STORAGE IN AN OPTICAL BURST SWITCH, LOCAL AREA NETWORK;”and
U.S. provisional patent application No. 60/472,634, titled “IMPLEMENTATION OF JUST-IN-TIME SIGNALING PROTOCOL IN OPTICAL BURST SWITCH WIDE AND LOCAL AREA NETWORK ARCHITECTURE;”
   all of which were filed on May 22, 2003. The disclosures of the above-identified patent applications are incorporated herein by reference in their entireties.

### FIELD OF THE DISCLOSURE

The present disclosure relates to novel architecture of advanced optical communication networks and, more particularly, to an Optical Burst-Switching (OBS) network, such as a Wide Area Network (WAN) and/or Local Area Network (LAN), with Just-In-Time (JIT) signaling and additional advanced data access features.

### BACKGROUND OF THE DISCLOSURE

Optical networks employing dense wavelength division multiplexing (dWDM) provide vast bandwidth capacities for data transmissions using optical medium. dWDM bridges the gap between lower electronic switching speeds and ultra high bandwidth available within the optical medium. dWDM divides the enormous information carrying capacity of a single mode fiber into a number of channels, each on a different wavelength carrying both analog and digital data, making it possible to deliver an aggregate throughput on the order of terabits per second. As such, dWDM is able to provide a faster networking infrastructure. Current communication technologies that adopt optical network and dWDM usually use wavelength routing with permanent or statically provisioned circuits that are set up between end-points for data transfer. However, permanent or staticaiiy provisioned circuits increase cost and lack flexibility.

While optical communication links are common in core and metropolitan networks, the progress has been slower in the local area data transmissions and access, especially in local area networks (LANs). As a result, the telecommunication industry, in general, prefers to expand on the success of a point-to-point network, such as Ethernet, by adopting new standards thereof, like GigE (Gigabit Ethernet) and 10GigE (10 Gigabit Ethernet) standards. In addition, communications within the confines of a host are accomplished via an electronic bus because available bandwidth is limited. Industry reluctance has been fueled by many factors, including the reality that an all-optical LAN requires a completely new set of components, such as tunable lasers, tunable filters, amplifying passive star couplers and the like.

Thus, there is a need to develop all-optical architecture for a local area network using switching technologies that facilitate communications between nodes within an all-optical local area network, and reduce complexity and inflexibility of permanent or statically provisioned circuits that are needed in conventional optical networks. There is also a need to develop an optically inclusive local area network that provides for data transparency, i.e., a network that is capable of concurrent transmission of arbitrary signal types, including analog signals (such as radar, NTSC video, sensor signals, etc.), digital signals, signal modulations and any other types of signal formats that would be used to implement data transmissions. The desired network will also encompass seamless memory access, whereby nodes in the network are capable of addressing memories of other nodes seamlessly.

### SUMMARY OF THE DISCLOSURE

The present disclosure describes advanced methods and architecture of Optical Burst Switch (OBS) networks, such as Local Area Network (LAN) or Wide Area Network (WAN), with Just-In-Time (JIT) signaling and additional advanced features such as arbitrary signal data transmission, memory access, single wavelength transmit/receive communication, and unified global address scaling. An Optical Burst Switch (OBS) Wide Area Network (WAN) or Local Area Network (LAN) provides low latency and a carrier independent data path. Additionally, an OBS network according to this disclosure is agnostic with respect to signal type and format. Thus, the network can carry a wide variety of analog and digital formats concurrently.

Exemplary architecture of an Optical Burst Switch (OBS) network comprises an optical signal bus that includes a signal coupling device, such as a passive star coupler or an array waveguide grating, and a plurality of network adapters that are in optical communication with the optical signal bus and in network communication with network terminal devices. The network adapters may include tunable receivers, transmitters and control logic that allows bi-directional movement of data signals as bursts between the terminal equipment and the OBS network. Additionally, the OBS network includes an optical bus controller in optical communication with the optical signal bus via a single or multiple wavelength(s) or channel(s) out of band from the data channels, to process signals from the optical signal bus to connect a requested network adapter to a requesting network adapter in accordance with a predetermined user-to-network protocol.

In one embodiment, the optical signal bus may be implemented as a LAN, and the network adapters take on the role of conventional network interface cards (NIC) by connecting the LAN to the internal bus of a client or server computer. Device drivers in the terminal host's operating system provide linkage between legacy network protocols, such as TCP/IP and the Network adapter, or any other types of protocols that may be used as legacy network protocols. Alternative protocol stacks may also be supported, such as Fiberchannel, or the newly emerging Transport layer protocols, defined for JIT networks.

In another embodiment, the optical signal bus includes a plurality of optical filters, each filter having an input that receives an input optical signal, a first output that transmits a control channel signal to an optical bus controller, and a second output that transmits a data signal on an individual wavelength. The optical data signal bus includes a signal coupling device, such as a star coupler, that acts as the central hub for the network. The star coupler has a plurality of data inputs in optical communication with the second outputs of the plurality of optical filters, and a plurality of outputs that transmit a combined data signal on individual wavelengths. The combined data signal is received by the inputs of a plurality of optical couplers, each coupler having a first input that receives a control channel signal transmitted from the optical bus controller, a second input that receives the combined data signal transmitted from the star coupler, and an output that transmits an output optical signal.

According to still another embodiment, an optical bus network adapter for implementation in an Optical Burst Switch (OBS) network includes an optical filter having an input that receives an inputted optical signal, a first output that transmits a data signal and a second output that transmits a control signal. The adapter also includes a data channel receiver having an input that receives the data signal transmitted from the optical filter and an output that transmits the data signal and a control channel receiver having an input that receives the control signal transmitted from the optical filter and an output that transmits the data signal. A physical layer interface is included in the adapter and comprises a first input that receives the control signal from the control channel receiver, a second input that receives the data signal from the data channel receiver, a first output that that transmits the control signal and a second output that transmits the data signal.

The adapter also includes a control message processor having a first input that receives the control signal from the physical layer interface and an output that transmits a control message, wherein the control message processor is in communication with an adapter control processor and a buffer memory to determine control criteria and an electronic backplane interface having a first input that receives the data signal from the physical layer interface, a second input that receives the control message from the control message processor and an output that transmits the data signal and the control message.

An optical bus controller implemented in an exemplary Optical Burst Switch (OBS) network may include a plurality of optical to electrical converters, each converter having an input that receives an optical signal and an output that transmits an electrical signal to a plurality of ingress message engines, each ingress engine having an input that receives the output of an optical to electrical converter, wherein the ingress message engine parses the message and acts based on current state and protocol responses. The bus controller includes an address resolution table that communicates with the plurality of ingress message engines to provide the ingress message engines with forwarding information and channel arbitration logic that communicates with the plurality of ingress engines to determine forwarding schedule based on inputs from the ingress engines and the address resolution table. The controller also includes a plurality of egress message engines, each egress engine having an input that receives communication from the channel arbitration logic and an output that transmits scheduling data and a plurality of electrical to optical converters, each converter having an input that receives data from the egress engines and an output that transmits data to the optical signal bus.

An exemplary method manages concurrent signal transmission through the OBS network of arbitrary signal types. For example, digital signals, analog signals, modulated signals and the like are transmitted through the OBS network concurrently. The method employs Optical Switch Bus (OBS) architecture in conjunction with the Just-In-Time signaling protocol to realize a network capable of data transparency.

In yet another embodiment of the disclosure, a network management method provides comprehensive memory access in a Local Area Network (LAN). According to the exemplary method, nodes in the network are configured to seamlessly address memories of other nodes that comprise the network. The management method allows the OBS network to merge WAN/LAN applications and Storage Area Network (SAN) applications.

According to another embodiment, a network management method is provided to allow transmission and receipt of optical signals on a single wavelength, to eliminate the need for optical signaling components in the network architecture. For example, the method may be implemented by allowing one wavelength per network adapter, which provides for passive device implementation as opposed to active switching components. When implemented in an OBS network, a passive star coupler or an array waveguide grating may serve as a passive non-blocking switch. The exemplary method may further allow unified global addressing scaling from CPU address space to Wide Area Network (WAN) in combination with OBS architecture. Contrary to conventional fixed length addressing, this method provides a more efficient means of network addressing.

Still other advantages of the presently disclosed methods and systems will become readily apparent from the following detailed description, simply by way of illustration of the disclosure and not limitation. As will be realized, the capacity planning method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The accompanying drawings, which are incorporated in and constitute a part of the specification, illustrate exemplary embodiments.

FIG. 1 is a block diagram of an exemplary Optical Burst Switch (OBS) Local Area Network (LAN).

FIG. 2 depicts a block diagram of an exemplary optical signal bus for use in an OBS LAN.

FIG. 3 shows a block diagram of an exemplary optical bus network adapter component of an exemplary OBS LAN.

FIG. 4 is a block diagram of an exemplary optical bus signal controller for use in an OBS LAN.

FIG. 5 is a flow diagram depicting a method for concurrent data transmission of arbitrary signal types through an OBS LAN implementing JIT signaling protocol.

FIG. 6 is a signaling scheme diagram for Just-In-Time (JIT) signaling implemented in conjunction with an OBS LAN or WAN, in accordance with an embodiment of the present disclosure.

FIG. 7 is a flow diagram of an exemplary method for transmission and receipt of optical data on a single wavelength per adapter in an OBS LAN implementing JIT signaling.

FIG. 8 is a flow diagram depicting the steps of an exemplary method for memory access in an OBS LAN implementing JIT signaling.

FIG. 9 depicts a block diagram of an exemplary optical bus switch for use in conjunction with JIT signaling.

FIG. 10 shows a block diagram of exemplary memory nodes and associated memory.

FIG. 11 is a flow chart illustrating the steps of a method for unified global address scheming in an OBS LAN implementing JIT signaling.

### DETAILED DESCRIPTION OF THE DISCLOSURE

In the following description, for purpose of explanation, numerous specific details are set forth in order to provide a thorough understanding of the present disclosure. It will be apparent, however, to one skilled in the art that the present method and system may be practiced without these specific details. In other instances, well-known structures and devices are shown in block diagram form in order to avoid unnecessarily obscuring the present disclosure.

An exemplary network according to this disclosure utilizes advanced burst switching technologies and Just-In-Time signaling protocols to manage and implement the network, which allow a switching network to deliver and switch data in variable-sized parcels, and substantially eliminate the need of permanent or statically provisioned circuits. Burst switching does not require buffering inside the network. Rather, switching of variable-sized bursts can be performed on the fly by using a reservation mechanism. Intermediate switches are only configured for a brief period of time, just enough to pass the burst, and are available to switch other bursts immediately after. The main difference from the packet switching paradigm is the lack of buffering and the much wider range of burst lengths, from very short (i.e., “packets”), to very long (i.e., “circuits”).

An OBS LAN is agnostic with respect to signal type and format, such that the network can carry a wide variety of analog and digital formats concurrently. The OBS LAN utilizes multiple wavelengths capable of being transported within optical fibers. The fiber contains multiple data paths within a single fiber connection. The OBS LAN allows for IP, iSCSI, and other protocols to be transported over these wavelengths to individually addressable Network Adapters (NA) or broadcast to any number of Network Adapters. The network adapters provide the interface between the network and the network terminal equipment, such as telephones, computers, servers, legacy network interfaces and the like. In addition, the network adapters provide hardwired control logic that allow for bi-directional movement of data signals as bursts between the terminal equipment and the network and data signal buffers that provide burstification control of data signal and timing for transmission and receipt of data signals. The network adapters also provide logic to support upper layer functions, including vector mapped direct memory access (DMA) and wire speed forward error correction (FEC), and a network interface that supports the user network signaling function while providing for a separate optical channel for the data signal transmit and receive function. The OBS LAN architecture supports both asynchronous single bursts with a holding time shorter than the diameter of the network, and switched optical paths with a holding time longer that the diameter of the network. The architecture provides out-of-band signaling on a single channel. The signaling channel undergoes electro-optical conversions at each node to make signaling information available to intermediate switches. In the OBS LAN architecture, the data channel/path is transparent to the intermediate network entities, i.e., no electro-optical conversion takes place at intermediate nodes, such as hubs, passive star couplers (PSCs) array waveguide gratings, and no assumptions are made about data rate or signal modulation. The architecture is such that most processing tasks are supported only at the edge nodes, with the core switches, hub and/or PSCs being kept simple. In addition, simplicity of the architecture is further achieved by not providing for global time synchronization between nodes.

Just-in-Time signaling refers to information transfers as bursts. A burst length is determined in terms of time and may range from a few nanoseconds to hours or days. JIT also makes no assumptions about the information format within a burst, which may be analog or digital. Furthermore, no assumption is made about the modulation method, or the information density (bit rate or bandwidth). In a network implementing Just-In-Time (JIT) signaling protocol, signaling messages are sent just ahead of the data to inform the intermediate switches. The common thread is the elimination of the round-trip waiting time before the information is transmitted. In the JIT approach, also referred to as the tell-and-go approach, the switching elements inside the switches of the network are configured for an incoming burst as soon as the first received signaling message announcing that burst is received.

In conjunction with the OBS LAN architecture, JIT signaling is performed out-of-band with the data being transparent to the intermediate network entities. This transparency means that no electro-optical conversion is done in intermediate nodes, such as passive star couplers (PSC), array waveguide gratings, hubs or switches, and no assumptions are made at the nodes concerning data rate or modulation methods. In a JIT implemented network, signaling messages are processed by all the intermediate nodes and, as such, electro-optical conversion is performed. Optical communication is conducted such that a single high-capacity signaling channel/wavelength is assigned per fiber. The basic assumption of the architecture is that data, aggregated in bursts, can be transferred from one point to the other by setting up the optical path just ahead of the data arrival. This assumption can be achieved by sending a signaling message ahead of the data to set up the optical communication path. Once the communication of data transfer is completed, the connection either times out or is released by the protocol.

Basic switch architecture presumes the existence of a number of input and output data and/or signaling ports, each carrying multiple wavelengths. A separate wavelength on each this port is dedicated to carrying the JIT signaling protocol. Any wavelength (excluding the signaling channel wavelength) on an incoming port can be switched to either the same wavelength on any outgoing port (no wavelength conversion) or any wavelength on any outgoing port (partial or total wavelength conversion). Switching time is presumed to be in the sub-microsecond range. In this architecture, a signaling message attempting to setup a path for a burst to travel from one end point to the other must inform all intermediate switches or components of the WAN of the arrival of the burst to allow them to set up their optical cross connect configuration(s) to channel the data on one of the data wavelengths. It also can optionally inform them of the duration of the burst. Typically, each switch in the network will be configured with a scheduler, which will be able to keep track of switching configurations, such as wavelength utilization, and assign them on time to allow the data to pass between the respected nodes.

Hardware Architecture

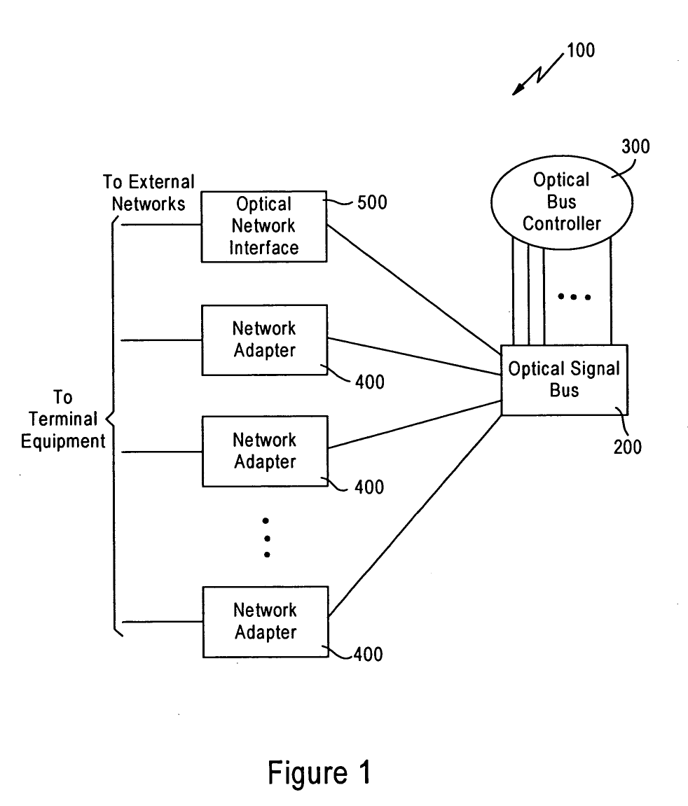

FIG. 1 depicts an exemplary OBS LAN that implements JIT signaling protocol. The network is characterized as being folded and a fully duplexed network. The OBS LAN 100 comprises an optical signal bus 200, an optical bus controller 300 and a plurality of network adapters 400. Collectively, the optical bus controller 300 and the optical signal bus 200, are referred to as hub. In addition, the optical signal bus 200 will typically be in network communication with one or more optical network interface devices 500, which are outside the OBS LAN 100 and provide network interface to external networks. For instance, network adapters may be UNI (User to Network Interface) devices and network interface devices 500 may be NNI (Network to Network Interface) devices.

The optical signal bus 200 is in network communication with the optical bus controller 300 and the plurality of network adapters 400. The network adapters 400 provide network connectivity to terminal equipment, such as server systems, telephones, computers, legacy network interfaces and the like. Fiber pairs, consisting of a transmit and receive fiber, interconnect the plurality of network adapters 400 with the optical signal bus 200. Each fiber in the pair carries two optical signals: (1) a digital control channel for transmitting and/or receiving control signals, and (2) a data channel for transmitting and/or receiving data from one node within the network to another. The control channels in the system all use the same wavelength and provide a dedicated path between each network adapter 400 and the optical bus controller 300. Each network adapter 400 has a unique wavelength that it uses to transmit over the data channel. Each adapter's receiver is capable of rapidly tuning, either electronically or optically, to the transmit wavelength of another adapter with which it wishes to communicate. The optical signal bus 200 distributes the optical signal from a transmitting adapter to all adapters connected to the bus 200. The optical bus controller 300 provides a contention resolution protocol for use of the adapter's receive channel. Since each adapter has a unique transmit wavelength, it may be feasible for all adapters to simultaneously use the bus 200 without contention, provided that each transmitter seeks a different destination.

(1) Optical Signal Bus

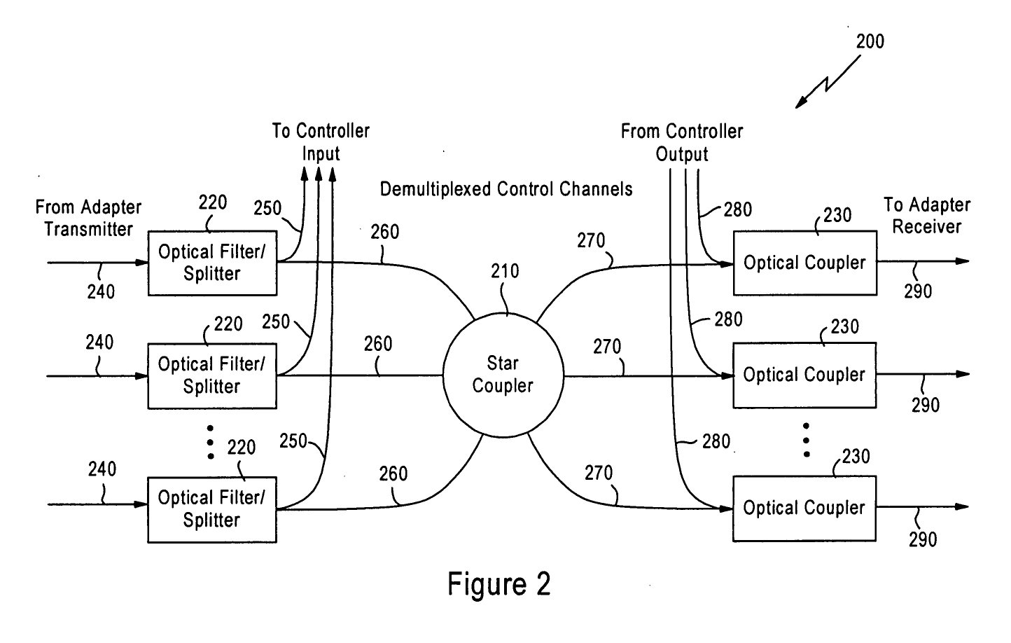

The exemplary OBS LAN 100 as shown in FIG. 1 uses a passive star coupler or an array waveguide grating as a central hub. FIG. 2 depicts a block diagram of the architecture for the optical signal bus 200 of the OBS LAN 100, in accordance with an embodiment of the present disclosure. The optical signal bus 200 is characterized as being an unfolded, fully duplexed network. The optical signal bus 200 includes a star coupler 210, a plurality of optical filters 220, and a plurality of optical couplers 230. The optical bus controller 300 generates and processes signaling messages and maintains states. Data is passed to the host with status information.

The plurality of optical filters 220 and optical couplers 230 are in a one-to-one relationship with corresponding network adapters 400 (not shown in FIG. 2). Fibers 240 provide network connectivity between transmitters of the plurality of network adapter 400 (not shown in FIG. 2) and the plurality of optical filters 220. The plurality of optical filters 220 serve to split out the control channel, i.e., the signaling channel, which is a dedicated wavelength, from the adapter transmit signal, and pass the control channel to the optical bus controller 300 (not shown in FIG. 2) via control channel transmit fibers 250. In addition, the plurality of optical filters 220 serve to split out the data signal portion of the adapter transmit signal, and pass the data signal portion to the star coupler 210 via fibers 260.

The star coupler 210 serves to combine the data signals being transmitted from the plurality of network adapters 400, each data signal being transmitted on a separate wavelength. Once the data signals are combined, the star coupler 400 splits the combined signal and distributes the combined signal to each of the plurality of optical couplers 230 via fibers 270. The plurality of optical couplers 230 serve to combine the output control channel signal that is transmitted from the optical bus controller 300 via fibers 280 and the corresponding data channel signal onto a fiber 290, which is connected to the receiver of one of the plurality of network adapters 400.

The star coupler 210 may be a passive device if a minimal number of network adapters 400 are employed in the OBS LAN 100. For example, if eight (8) or fewer network adapters 400 are used in the network 100, limiting the number of channels used to eight (8) or fewer, the star coupler 210 may be a passive device. If more network adapters 400 and thus more channels are used, then optical amplification may be required in the star coupler 210 to overcome losses in the signal due to splitting and the like.

(2) Network adapters

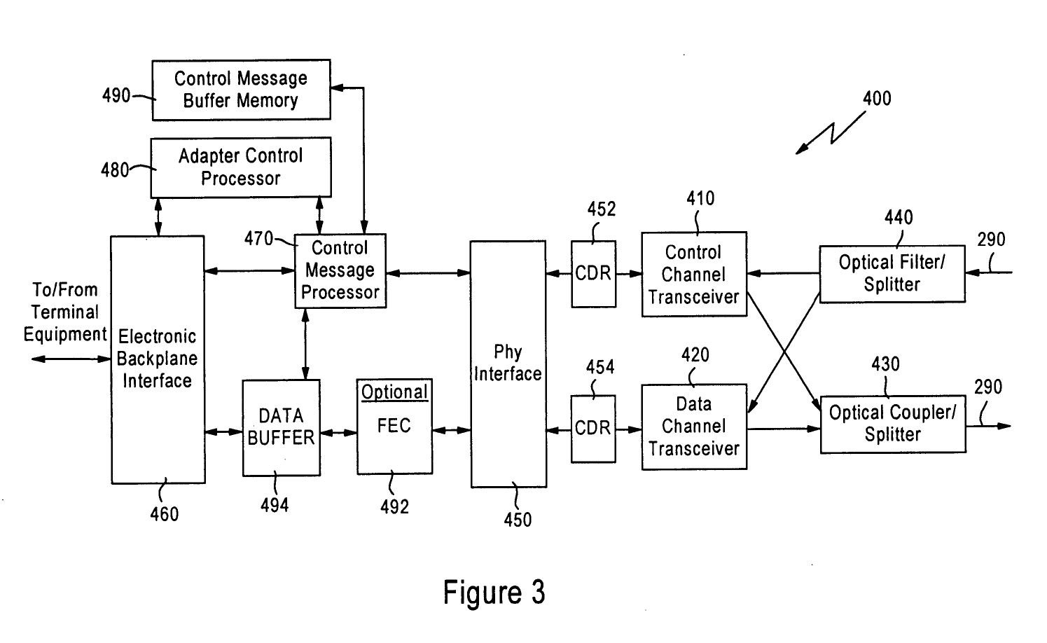

FIG. 3 illustrates a block diagram of a network adapter 400 implemented in the OBS LAN 100, in accordance with an embodiment of the present disclosure. The network adapters 400 provide the interface between the network and the network terminal equipment, such as telephones, computers, servers, legacy network interfaces and the like, that couple to the OBS LAN 100. In addition, the network adapters 400 provide hardwired control logic that allows bidirectional movement of data signals as bursts between the terminal equipment and the network and data signal buffers that provide timing to transmission and receipt of data signals. The network adapters 400 also provide logic to support upper layer functions, including vector mapped direct memory access (DMA) and wire speed, forward error correction (FEC), and a network interface that supports the user network signaling function while providing for a separate optical channel for the data signal transmit and receive function.

The network adapter 400 comprises two sets of transmitters and receivers corresponding to the control channel transmitter and receiver 410, and the data channel transmitter and receiver 420. On the transmit side, an optical coupler 430 combines the control channel signal with the data channel signal, and sends the combined signal on to fiber 240. On the receive side, an optical filter 440 separates out the control channel signal from the data channel signal received from fiber 290.

The control channel and data channel receivers may be fixed or tunable receivers. By way of example, the tunable receiver may comprise a wavelength filter device, which outputs to an array of dense Wavelength Division Multiplexing (dWDM) optical wavelengths that receivers perform OE conversion on and the output of the receivers are electronically switched. Other means for providing tunable receiver functions also can be use, and are within the scope of this disclosure. The control channel and data channel transmitters may be fixed or tunable transmitters. In limited embodiments, the transmit laser could be tuned to a fixed wavelength. However, in most cases, large scale networked tunable lasers will be required to manage data flow within the OBS LAN 100. In one example, one of the control channel receiver and transmitter is tunable. Similarly, one of the data channel receiver and transmitter is tunable.

The control channel transmitter and receiver 410 controls the tuning of transmission and receipt of communications via Just-In-Time user-to-network protocol. The control channel is provided via an optical path and typically requires a framing structure. A coding scheme that ensures DC balance of the bit stream is used to convert the data bits into frames. A preamble at the beginning of the frame is used for frame synchronization at the receiver end.

For example, a 64/66B or 8/10B coding scheme may be used to convert the data bits into frames. The 64/66B scheme is preferred because it offers the advantage of lower bandwidth overhead. To maintain link synchronization, idle patterns may be transmitted from the control channel to the optical signal bus 200 when data is not being sent. Additionally, data octets are typically scrambled prior to transmission using a known scrambling scheme.

The control channel typically operates at a frequency greater than about 500 MHz or 1 Gbps to minimize signal throughput delay. The control channel may be transported via a separate optical fiber or as a dedicated International Telecommunication Unit (ITU) dWDM wavelength within the data path fiber. When being transported via a wavelength within the data path fiber the control channel is de-multiplexed and undergoes optical to electric conversion at the input and output port interfaces to the hub.

In operation, once the network adapters 400 are connected to the OBS LAN 100 optical signal bus 200, the network adapters 400 will frame up to the bus 200 and then assert a node present packet over the control channel. The optical signal bus 200 verifies the link and assigns an address to the new node. The network adapter 400 uses this address for all further communications. A typical addressing scheme utilizing hierarchical node addressing with variable address length may be employed.

The control channel transmitter and receiver 410 and the data channel transmitter and receiver 420 are in communication with the physical layer (PHY) interface 450. The physical layer interface 450 provides the electrical and mechanical interconnection between the data communication equipment (DCE) and the data terminal equipment (DTE). The PHY interface 450 includes a series of modules that implement the optical transmitters and receivers.

Data received from the data channel transmitter and receiver 420 is passed directly to the electronic backplane interface 460 via the physical layer interface 450. The control channel transmitter and receiver 410 are in communication with the control message processor 470 via the physical layer interface 450. The control processor 470 implements the predetermined OBS LAN protocol, typically the Just-In-Time (JIT) protocol or another suitable protocol capable of optical burst switch communication. The control message processor 470 is protocal in communication with the adapter control processor 480 and buffer memory 490, which serves to control the timing of transmission and receipt of data communications within the OBS LAN 100. The buffer memory 490 is required to queue the data requests.

Forward Error Correction (FEC) 492 is optionally implemented in specific embodiments of the network adapters 200 of the present disclosure. It is desirable to minimize the need for retransmission of data bursts when bit errors are detected in the network and for bursts lost due to blocking in the core network. For example, in chip-to-chip and board-to-board communication it may not be necessary to have forward error correction. In addition, FEC may be required in Local Area Network and Wide Area Network environments where the Bit Error Rate (BER) becomes high.

(3) Optical Bus Controller

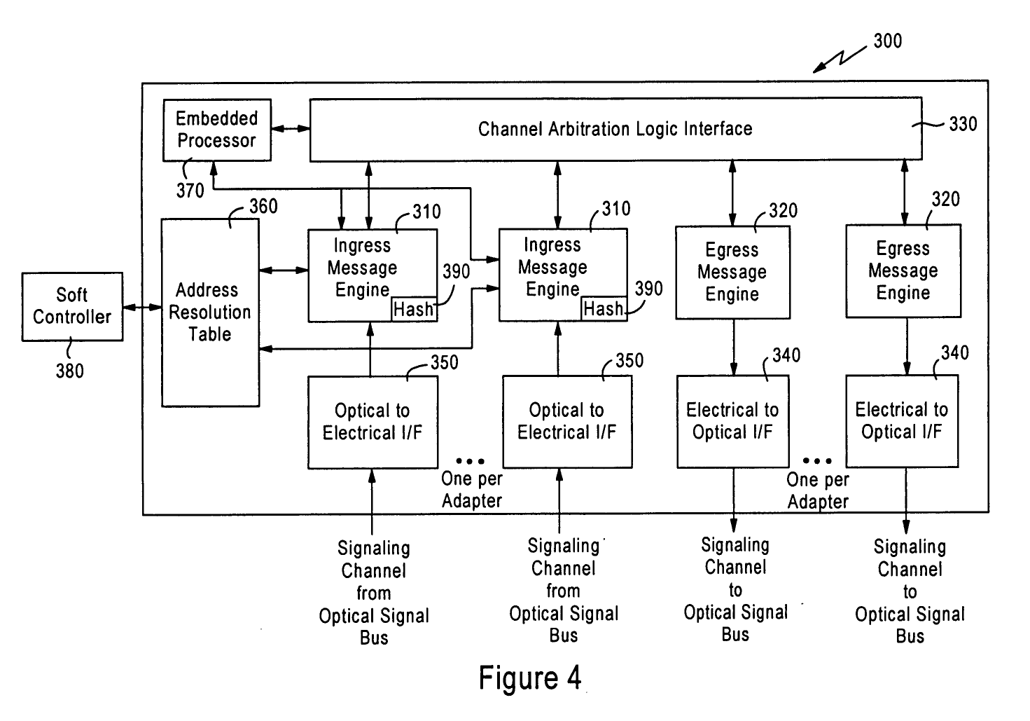

FIG. 4 depicts a block diagram of an optical bus controller 300 implemented in the OBS LAN 100, in accordance with an embodiment of the present disclosure. The bus controller 300 utilizes hardware protocol acceleration to process signal channels. The controller 300 processes signaling channels to connect requested network adapters 400 to the requesting network adapter 400 in accordance with the user-to-network protocol. The optical bus controller 300 forwards the transmitter and receiver tuning information to the requested network adapter 400. Based on the tuning information, the requested network adapter 400 tunes its receiver to properly receive data bursts initiated by the requesting network adapter 400. The bus controller 300 also implements the JIT network-to-network protocol to support LAN interconnection.

The optical bus controller 300 comprises a plurality of ingress engines 310 (one per control channel or common across multiple control channels), a plurality of egress engines 320 (one per control channel or common across multiple control channels). The optical bus controller 300 further includes an arbitration circuit 330, electrical to optical (E/O) converters 340, optical to electrical (O/E) converters 350, a forwarding data table 360, and an embedded processor 370.

JIT protocol messages are received on the signal channel from the optical signal bus 300 and undergo optical electrical conversion via O/E converters 350. After the conversion process is completed, the ingress engines 310 parse the JIT messages and take actions based on current state information stored in connection table (such as Hash table), and protocol responses as defined in a finite state machine in accordance with the JIT protocol. Most messages will require looking up forwarding information from the forwarding tables 360, and communication with one or more of the egress engines 320 through the arbitration logic 330. Some messages cannot be handled by the Ingress engine 310 are passed to the embedded processor 370 for more involved and time intensive decision functions and actions.

The arbitration logic 330 is a circuit that passes messages from the ingress engine 310 to the egress engines 320 based on results of forwarding table 360 lookups. In cases where multiple requests go to the same egress engine 320 simultaneously, the channel arbitration logic 330 decides which request to serve. In those instances that a requested egress engine 320 is busy serving another request, the arbitration logic 330 conveys a busy signal to the ingress engine 310.

The forwarding table 360 includes information that maps the logical system addresses to the physical ports of the system. This allows arbitrary assignment of system addresses to the physical ports in the system. It also is used to direct to the right location, information destined to addresses outside those directly connected to the bus. In this regard, the forwarding table 360 is typically in communication with a software controller 380 that is outside of the optical bus controller architecture.

The JIT Protocol

As mentioned above, according to an embodiment of this disclosure, the OBS LAN 100 implements data communications using optical bursts, such as Just-In-Time control protocol. Just in Time refers to all information transfers as bursts. A burst length is determined in terms of time and may range from a few nanoseconds to hours or days. JIT also makes no assumptions about the information format within a burst. Therefore, the information within a burst may be analog or digital. No assumption is made about the modulation method or the information density (bit rate or bandwidth).

A request to use a bus is initiated with a SETUP message sent by the originator of a burst to the optical bus controller 300. The SETUP message carries parameters related to the connection. These parameters include a burst descriptor, a Quality of Service (QoS) descriptor, end-to-end connection parameters, a connection reference number, and a wavelength to permit wavelength conversion along the path and interoperability with wireless networks. The optical bus controller 300 consults with delay estimation mechanism based on the destination address and returns the updated delay information to the originator by using SETUP ACK message, and at the same time acknowledges receipt of the SETUP message. The SETUP ACK message also informs the originating node, i.e., the originator of the burst, which channel/wavelength to use when sending the data burst.

The originator waits the required amount of time based on its knowledge of the round-trip time to the optical bus controller 300, and then sends the burst on its transmit wavelength. The SETUP message at the same time is traveling across the bus control channel, informing the destination of the burst arrival. If no blocking occurs on the path, the SETUP message reaches the destination node, which then receives the incoming burst shortly thereafter. Upon receipt of the SETUP message, the destination node may choose to send a CONNECT message acknowledging a successful connection.

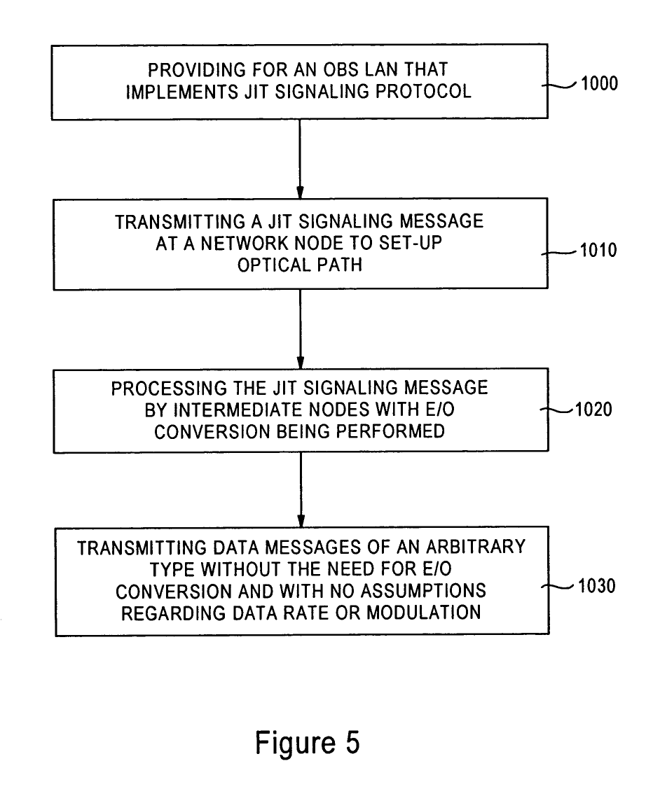

FIG. 5 illustrates an exemplary method to perform data transmission in an exemplary OBS network implementing JIT signaling, according to an embodiment of this disclosure. At step 1000, an optically inclusive OBS LAN that implements JIT signaling protocol is provided. JIT signaling is characterized by signaling being performed out-of-band with the transmitted data being transparent to the intermediate network entities. This transparency means that no electro-optical conversion is done in the intermediate nodes. At step 1010, a JIT signaling message is sent by a node on the OBS network to set-up the optical path for a subsequent data transmission message. At step 1020, the JIT signaling message is processed by intermediate nodes in the network with electro-optic conversion being performed. At step 1030, data transmission messages of an arbitrary type are transmitted through the OBS LAN architecture. The arbitrary messages may be analog data transmissions, digital data transmissions, modulations or the like. As the data transmissions are communicated through the network, electro-optical conversion is unwarranted and no assumptions are made at the nodes, including the intermediate nodes, concerning data rate or modulation methods. Different from transmission of data, signaling messages are processed by intermediate nodes, such as hubs and passive star couplers (PSCs) or array waveguide gratings and, as such, electro-optical conversion is performed. Optical communication is conducted such that a high-capacity signaling channel/wavelength(s) is assigned per fiber. The basic assumption of the architecture is that data, aggregated in bursts, can be transferred from one point to the other by setting up the optical path just ahead of the data arrival. This assumption can be achieved by sending a signaling message ahead of the data to set up the optical communication path. Once the communication of data transfer is completed the connection will be timed out.

JIT signaling utilizes a hierarchical addressing scheme with variable length addresses. Each address field is represented by an address LV (Length, Value) tuple. The length of the address (such as in bytes) is allocated 8 bits, thus allowing a maximum of a 2048 bit address length. The idea of hierarchical addressing presumes that different administrative entities can be responsible for assigning a part of the address hierarchy, with discretion being left to the length and the further hierarchical subdivision of address space. The JIT signaling is contrary to the fixed length addressing schemes, where blocks of addresses must be allocated for different entities thus resulting in inefficient use of address space.

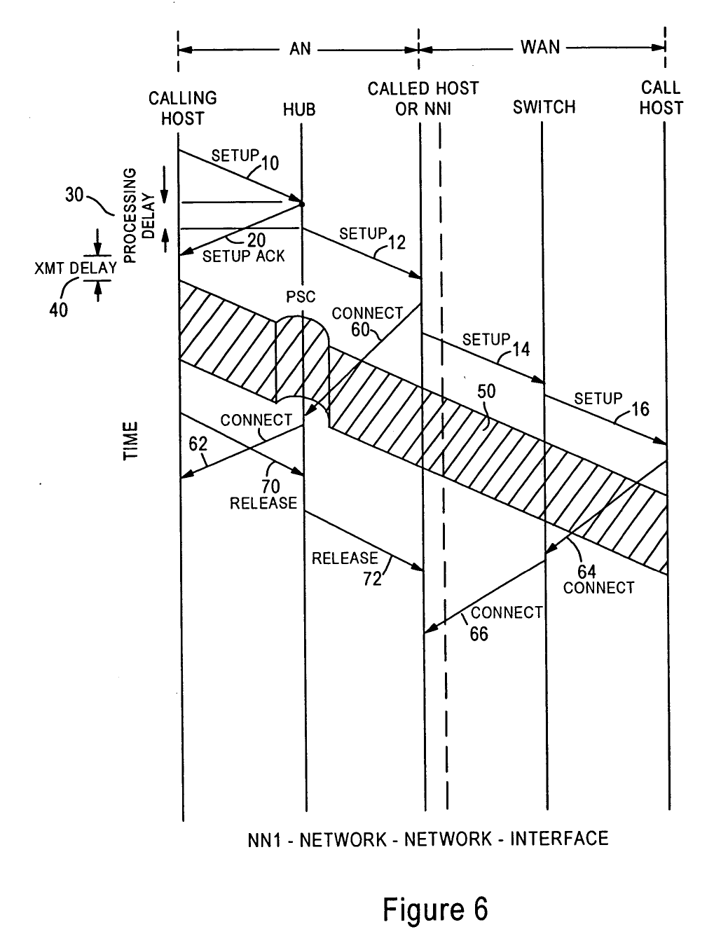

FIG. 6 shows a signaling scheme diagram for Just-In-Time (JIT) signaling implemented in conjunction with an OBS LAN/WAN, in accordance with an embodiment of the present disclosure. In FIG. 6, explicit setup and teardown of the connection is performed. Signaling messages, in the form of SETUP messages sent by the calling host trigger intermediate nodes, such as switches or hub with PSC, i.e., the calling switch and the called switch, to configure the cross-connects for the incoming connection. Additional signaling messages, in the form of RELEASE messages, announce when the cross-connect element is available for a new connection.

A request to use a bus is initiated with a SETUP message 10 being sent by a calling host (such as a network adapter 400) that is scheduled to send out data embedded in a burst, to the optical bus controller 300 (such as a hub). The optical bus controller 300 consults with a delay estimation mechanism, such as ingress engine and address resolution table as discussed earlier, based on the destination address and returns the updated delay information to the calling host by sending a SETUP ACK message 20, which acknowledges receipt of the SETUP message. The SETUP ACK message also informs the originating node which channel/wavelength to use when sending the data burst.

The calling host waits the required amount of transmission delay time (XMT DELAY) 40 based on its knowledge of the round-trip time to the optical bus controller, and then sends the optical burst on its transmit wavelength. The SETUP message 12, 14, 16 at the same time is traveling across the bus control channel, informing the destination of the burst arrival.

If no blocking occurs on the path, the SETUP message 12 reaches the called host, which then receives the incoming optical burst 50 shortly thereafter. The SETUP message carries with it parameters related to the optical burst connection. These parameters include, but are not limited to, a burst descriptor; a Quality of Service (QoS) descriptor, including required connection bandwidth and priority; the end-to-end connection parameters, including encoding scheme, modulation scheme, and signal type; a connection reference number unique to the calling host; and a designated wavelength to permit wavelength conversion along the path and interoperability with wireless networks.

Upon receipt of the SETUP message 12, the called host may choose to send a CONNECT message 60 acknowledging the successful completion of the connection. The receipt of the SETUP by the called host only indicates that the connection has been established, but does not guarantee its successful completion, since a connection may be preempted somewhere along the path by a higher-priority connection. The OBS LAN may connect to a WAN and support both asynchronous single bursts with a holding time shorter than the diameter of the network and switched optical paths with a holding time longer that the diameter of the network. The architecture provides out-of-band signaling on a separate channel. The signaling channel undergoes electro-optical conversions at each node to make signaling information available to intermediate hubs. In the OBS LAN architecture, data is transparent to the intermediate network entities, i.e., no electro-optical conversion takes place at intermediate hubs and no assumptions are made about data rate or signal modulation. Most message processing is supported only at the edge switches, with the core switches being kept relatively simple. In addition, simplicity of the architecture is further achieved by not providing for global time synchronization between nodes, which requires fast clock recovery at the nodes.

Basic switch architecture presumes that a number of input and output ports are provided, each of which carries multiple wavelengths. A separate wavelength on each port is dedicated to carrying the JIT signaling protocol. Any wavelength on an incoming port can be switched to either the same wavelength on any outgoing port (no wavelength conversion) or any wavelength on any outgoing port (partial or total wavelength conversion). The switching can be performed by using suitable switching technology known to people skilled in the art, such as MEMS (Micro-electromechanical systems) micro-mirror arrays, SOA, TIR or the like. Switching time is presumed to be in the sub-microsecond range. In this architecture, a signaling message attempting to setup a path for a burst to travel from one end point to the other must inform all intermediate switches of the arrival of the burst to allow them to set up their configuration, such as mirror configuration, to channel the data on one of the data wavelengths. It also can optionally inform them of the duration of the burst. Typically, each switch in the network will be configured with a scheduler, which will be able to keep track of wavelength switching configurations and switch them on time to allow the data to pass through.

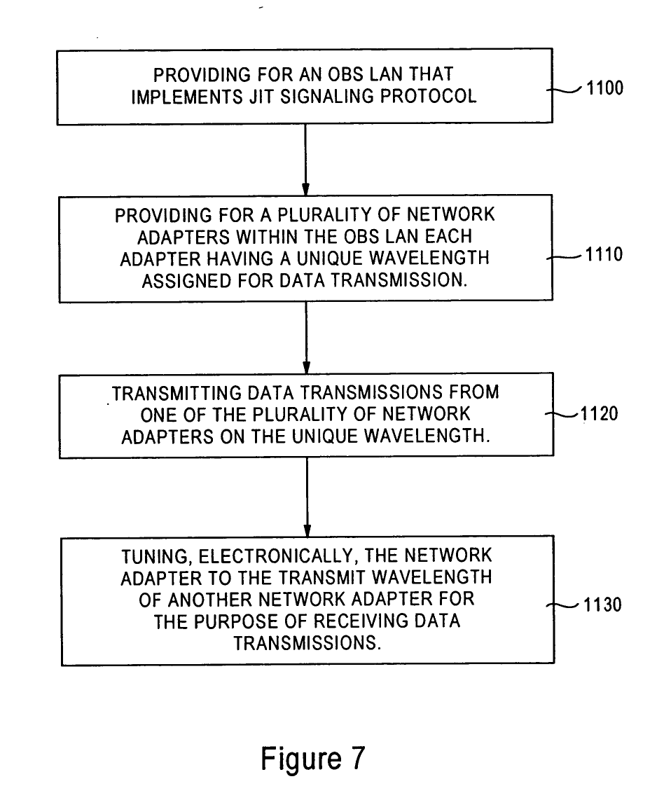

In an alternate embodiment, a method for single optical wavelength transmission and reception is described in FIG. 7. At step 1100, an OBS network that implements JIT signaling protocol is provided. At step 1110, a plurality of network adapters are provided within the OBS network with each adapter having a unique and dedicated wavelength for optical data transmission. At step 1120, one of the plurality of network adapters communicates data transmissions on the unique and dedicated wavelength. At step 1130, the network adapter is electronically tuned to the transmit wavelength of another network adapter for the purpose of receiving data transmissions from the other network adapter. The optical bus is capable of distributing the optical signal from a transmitting adapter to all adapters in the network that are connected to the optical bus. The optical bus controller provides a contention resolution protocol for use of the adapter's receive channel. Since each adapter has a unique transmit wavelength, all adapters in the network can simultaneously use the bus without contention, provided that each transmitter seeks a unique destination.

In one embodiment, the JIT protocol described above is used as an optical bus interconnect protocol in conjunction with the OBS LAN. This has the advantage of providing more available memory bandwidth than that of conventional bus architecture. Additionally, the JIT signaling protocol makes large amounts of memory available to different applications as local memory. It is also beneficial that use of the JIT protocol in conjunction with the OBS LAN architecture provides a seamless merge of LAN or WAN, and Storage Area Networking (SAN) applications.

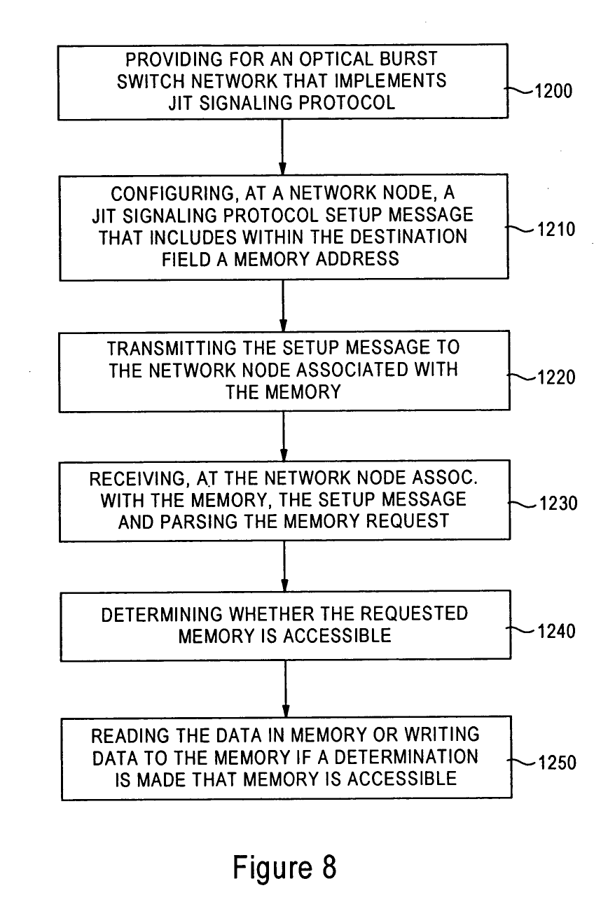

In accordance with another embodiment of the disclosure, a method for memory access in an OBS network implementing JIT signaling is illustrated in FIG. 8. At step 1200, an optical burst switch network that implements just-in-time signaling protocol is provided. At step 1210, a network node configures a JIT signaling protocol setup message that includes an address of a memory location within the destination address field. At step 1220, the network node transmits the setup message to the destination network node associated with the memory. At step 1230, the network node associated with the memory receives the setup message, and parses the memory request. At step 1240, a determination is made whether the requested memory is currently accessible. At step 1250, if the memory is accessible, corresponding data is read from the memory or written into the memory.

The current JIT protocol has an address field up to 2048 bits, which will be able to support access to individual bytes inside these nodes. In one embodiment, DRAMS are arranged in banks and a memory request can be accepted only if the corresponding bank is free. Therefore, for a 1 GB memory chip consisting of 4 banks, the destination address doesn't need to contain the 30-bits of the byte-level address. It only needs to specify the bank it needs access to, which can be done using only 2 bits.

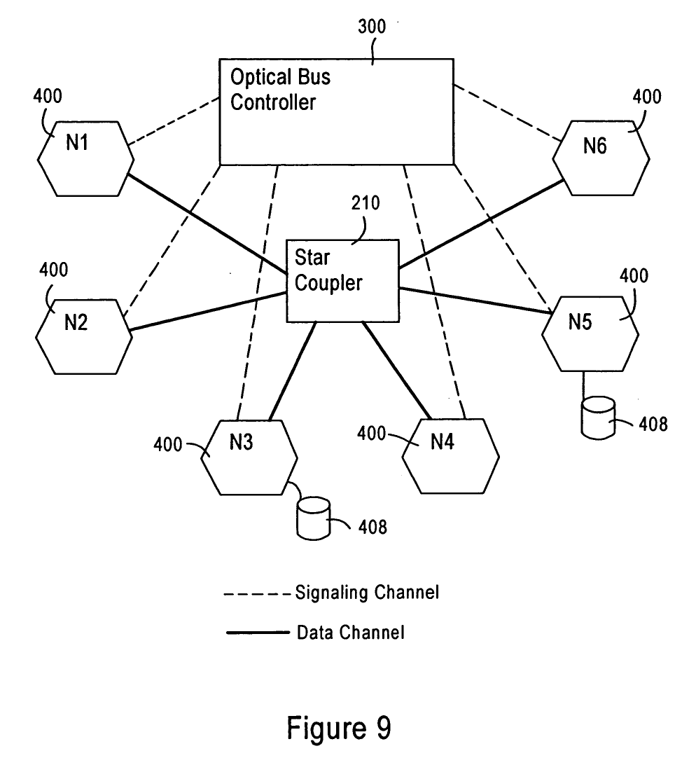

FIG. 9 depicts a block diagram of another embodiment of an optical bus switch network implementing JIT signaling. The optical bus controller 300 is in signaling channel communication with a plurality of nodes implementing network adapters 400. Additionally, the star coupler 210 is in data channel communication with the plurality of network adapters 400. Assuming that the network adaptors 400 for nodes N3 and N5 are in communication with large amounts of memory. For example, the bus adaptor nodes N3 and N5 can consist of large arrays of conventional memory 600 (e.g. DDR DRAMS) serving some or all the network nodes in the LAN. The destination address field corresponding to nodes N3 and N5 includes the address of the memory location that is being referenced. The remaining nodes N1, N2, N4 and N6 are network adapter nodes that access the memory stored in N3 and N5. The network adapter nodes 400 send signaling messages, such as SETUP, to the memory nodes N3, N5 to access the memory.

The exemplary JIT protocol has an address field up to 2048 bits, which will be able to support access to individual bytes inside nodes N3, N5. In one embodiment, DRAMS are arranged in banks and a memory request can be accepted only if the corresponding bank is free. Therefore, for a 1 GB memory chip consisting of 4 banks, the destination address doesn't need to contain the 30-bits of the byte-level address. It only needs to specify the bank it needs to access, which can be achieved using only 2 bits. The controllers for nodes N3 and N5 parse the SETUP message, and depending on whether the bank requested is busy or not, determine whether the request is denied or accepted. If the request is accepted, the bank is marked busy until the corresponding data is read or written. In other words, the memory banks work in exactly the same fashion as other nodes in the network.

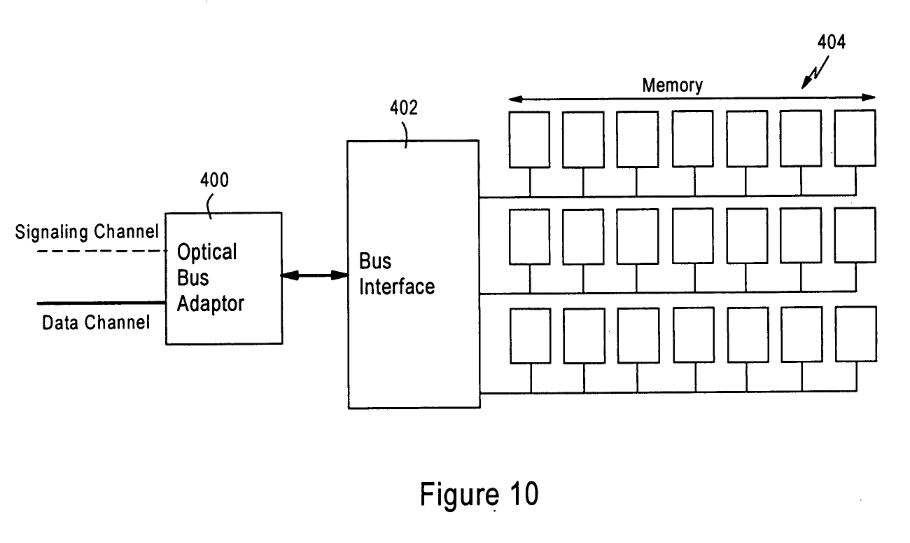

FIG. 10 depicts a block diagram of the memory nodes (nodes N3 and N5 of FIG. 9) and the associated memory, in accordance with an embodiment of the present disclosure. A network adapter 400 is in communication with a bus interface 402 that connects multiple conventional bus channels to the JIT optical bus. The bus interface 402 translates the incoming JIT optical bus request to access the corresponding memory bank 404. As an example, to read/write a large block of memory, a SETUP message is first sent to the bus interface 402 which checks whether the requested bank is busy or not. If the bank is available, the bus interface 402 demultiplexes the incoming data stream and generates the corresponding addresses to enable reads/writes to the memory bank 404. The bank becomes free again when the requested block has been read/written.

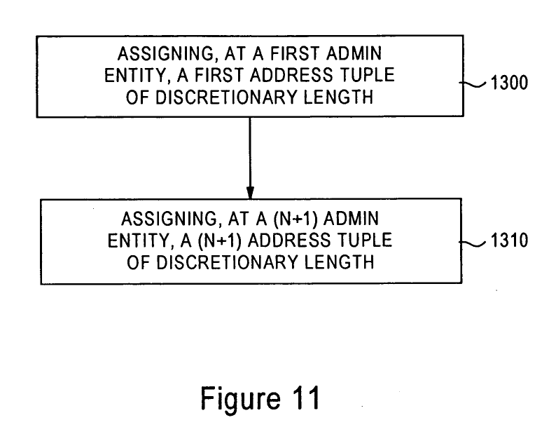

In another embodiment of the disclosure, a method for unified global addressing in an OBS LAN implementing JIT signaling processing is described by the flow diagram of FIG. 11. At step 1300, a first administrative entity assigns a first address tuple of discretionary length to an optical signal. At step 1310, a second administrative entity assigns a second address tuple of discretionary length. This process continues at all administrative entities until a hierarchical address is assigned to the optical signaling message. The length of the address is allocated 8 bits, thus allowing for a maximum of a 2048 bit address length. This method is contrary to the fixed length addressing schemes, where blocks of addresses must be allocated for different entities thus resulting in inefficient use of address space.

In another embodiment of the disclosure, the optical burst bus is used as a LAN and the network adapters take on the role of conventional network interface cards, connecting to the internal bus of a client or server computer. Device drivers in the terminal host's operating system provide linkage between legacy network protocols such as TCP/IP and the Network adapter. Alternative protocol stacks may also be supported, such as Fiberchannel, or the newly emerging Transport layer protocols, defined for JIT networks. According to another embodiment of the disclosure, the optical burst network system using JIT protocol as described above is implemented in whole or in part using satellite and/or wireless networks.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended Claims. Although specific terms are employed herein, they are used in a generic and descriptive sense only and not for purposes of limitation.

1. An Optical Burst Switch (OBS) network system comprising:
an optical signal bus including a signal coupling device;
a plurality of network adapters that are in optical communication with the optical signal bus and in network communication with network terminal devices, each of the network adapters coupled to terminal equipment, and including a receiver, a transmitter, and control logic that allows bi-directional transmission of data signals as bursts between the terminal equipment and the network system; and
an optical bus controller in optical communication with the optical signal bus, for processing signals received from the optical signal bus to establish signal communications between a requested network adapter and a requesting network adapter based on a request initiated by the requesting optical adapter.

2. The system of claim 1, wherein the signal coupling system is a passive star coupler or an array waveguide grating.

3. The system of claim 1, wherein the network system is a local area network (LAN).

4. The system of claim 1, wherein the optical adapters are coupled to computers.

5. The system of claim 1 further comprising an optical network interface configured to be in optical communication with the optical signal bus and in network communication with one or more external networks.

6. The system of claim 1, wherein the receiver and transmitter are fixed or tunable.

7. The system of claim 6, wherein at least one of the receiver and transmitter is tunable.

8. An optical signal bus for use in an Optical Burst Switch (OBS) network system, the optical signal bus comprising:
a plurality of optical filters, each filter having an input that receives an input optical signal, a first output configured to transmit a control channel signal to an optical bus controller, and a second output configured to transmit a data signal on an individual wavelength;
a signal coupling device including:
a plurality of inputs in optical communication with the second output of the plurality of optical filters, and
a plurality of outputs that transmit a combined data signal on individual wavelengths; and
a plurality of optical couplers, each of the couplers including:
a first input that receives a control channel signal initiated by the optical bus controller;
a second input that receives the combined data signal from the signal coupling device; and
an output configured to transmit an output optical signal.

9. The bus of claim 8, wherein the signal coupling device is a passive star coupler or and array waveguide grating.

10. An optical bus network adapter for use in an Optical Burst Switch (OBS) network system, the network adapter comprising:
an optical filter including:
an input for receiving an inputted optical signal;
a first output for transmitting a data signal; and
a second output for transmitting a control signal;
a data channel receiver having an input for receiving the data signal from the optical filter, and an output for transmitting the data signal;
a control channel receiver having an input for receiving the control signal from the optical filter, and an output for transmitting the data signal;
a physical layer interface including:
a first input for receiving the control signal from the control channel receiver;
a second input for receiving the data signal from the data channel receiver;
a first output for transmitting the control signal; and
a second output for transmitting the data signal;
a control message processor having a first input for receiving the control signal from the physical layer interface, and an output for transmitting a control message, wherein the control message processor is in communication with an adapter control processor and a buffer memory to determine at least one control criterion; and
a backplane interface including:
a first input for receiving the data signal from the physical layer interface;
a second input for receiving the control message from the control message processor; and
an output for transmitting the data signal and the control message.

11. An optical bus controller implemented in an Optical Burst Switch (OBS) network system, the optical bus controller comprising:
a plurality of optical-to-electrical converters, each of the converters including an input for receiving an optical signal, and an output for transmitting an electrical signal;
a plurality of ingress message engines, each of the ingress engines having an input for receiving the output of one of the optical-to-electrical converters, wherein the ingress message engine parses the output of the one of the optical-to-electrical converters, and acts based on current state and protocol responses;
an address resolution table configured to communicate with the plurality of ingress message engines to provide the ingress message engines with forwarding information;
a channel arbitration device for communicating with the plurality of ingress engines, to determine forwarding schedule based on inputs from the ingress engines and the address resolution table;
a plurality of egress message engines, each of the egress engines having an input for receiving communication from the channel arbitration device, and an output for transmitting scheduling data; and
a plurality of electrical-to-optical converters, each of the converters having an input for receiving data from the egress engines, and an output for transmitting data to the optical signal bus.

12. An Optical Burst Switch (OBS) network system comprising:
an optical signal bus that includes a signal coupling device;
a plurality of network adapters configured to be in optical communication with the optical signal bus, and in network communication with network terminal devices, wherein each of the network adapters is coupled to terminal equipment, and includes a receiver, a transmitter, and a control device, that allow bi-directional movement of data signals as bursts between the terminal equipment and the OBS network system; and
an optical bus controller in optical communication with the optical signal bus, for processing signals from the optical signal bus to establish communications between a requested network adapter and a requesting network adapter based on a predetermined communication protocol,
wherein the network system implements a just-in-time signaling protocol to signal one of the network adapters coupled to the network to indicate that burst communications are forthcoming.

13. The system of claim 12, wherein the signal coupling device is a passive star coupler or an array waveguide grating.

14. The system of claim 12, wherein the network system is a local area network (LAN).

15. The system of claim 12, wherein the receiver and the transmitter are fixed or tunable.

16. The system of claim 15, wherein at least one of the receiver and the transmitter is tunable.

17. A method for transparent data transmission in an optical network having a plurality of nodes, the method comprising the steps of:
providing an optically inclusive local area network that implements optical burst switch architecture;
transmitting a signaling message from a node to set-up an optical path for a subsequent data transmission message;
processing the signaling message at one node in the network with electro-optic conversion being performed; and
transmitting the data transmission message through the optical path in the local area network, wherein the data transmission message includes arbitrary types of data.

18. The method of claim 17 further including the step of implementing Just-in-Time (JIT) protocol in the local area network.

19. A method for single wavelength data transmission in an optically inclusive network, the method comprising the steps of:
providing an optical burst switch network;
providing a plurality of network adapters within the optical burst switch network, wherein each of the plurality of network adapters has a unique and dedicated wavelength for optical data transmission;
transmitting data from one of the plurality of network adapters on the unique and dedicated wavelength associated with the one of the network adapter; and
electronically tuning the one of the plurality of network adapters to the transmit wavelength of another network adapter for receiving data transmissions.

20. The method of claim 19 further including the step of implementing Just-in-Time (JIT) protocol in the optical burst switch network.

21. A method for memory access in an optical burst switch network including a plurality of network nodes, the method comprising the steps of:
providing for an optical burst switch network;
configuring, at one of the network nodes, a setup message that includes an address of a memory within a destination address field;
transmitting, from the one of the network nodes, the setup message to another network node associated with the memory identified by the memory location;
receiving the setup message at the another network node associated with the memory and parsing the setup message;
determining whether the memory requested by the setup message is currently accessible; and
accessing the memory in response to a result of the determining step indicating that the memory is accessible.

22. The method of claim 21 further including the step of implementing Just-in-Time (JIT) protocol in the optical burst switch network.

23. The method of claim 21, wherein the step of accessing the memory includes either reading data from the memory or writing data into the memory

24. A method for hierarchical addressing in an optical burst switch network, the method comprising the steps of:
assigning, at a first administrative entity, a first address tuple of a discretionary length; and
assigning, at (n+1)th administrative entity, an nth address tuple of a discretionary length.

25. The method of claim 24, wherein the optical burst switch network implements a just-in-time signaling protocol.
